(19) United States
(12) Patent Application Publication
(10) Pub. No.: US 2012/0285164 A1
(43) Pub. Date: Nov. 15, 2012

(54) TURBOCHARGED ENGINE WITH SEPARATE EXHAUST MANIFOLDS AND METHOD FOR OPERATING SUCH AN ENGINE

(75) Inventors: Kai Sebastian Kuhlbach, Bergisch Gladbach (DE); Norbert Andreas Schorn, Aachen (DE); Guenter Bartsch, Gummersbach (DE); Rainer Friedfeldt, Huerth (DE)

(73) Assignee: FORD GLOBAL TECHNOLOGIES, LLC, Dearborn, MI (US)

(21) Appl. No.: 13/459,828

(22) Filed: Apr. 30, 2012

(30) Foreign Application Priority Data
May 12, 2011 (EP) 11165846.4

(51) Int. Cl. F02B 37/007; F02B 37/18

(52) U.S. Cl. 60/602; 60/612

(57) ABSTRACT

Systems and methods for a turbocharged internal combustion engine are provided herein. One example system includes a cylinder head with at least two cylinders, at least two exhaust openings per cylinder, at least one of which is engageable. The system further includes a first exhaust manifold integrated in the cylinder head and connecting the engageable openings with a first turbocharger turbine, and a second, separate exhaust manifold integrated in the cylinder head and connecting the non-engageable openings with a second turbocharger turbine in parallel with the first turbine.

### RELATED APPLICATIONS

The present application claims priority to European Patent Application Number 11165846.4 filed on May 12, 2011, the entire contents of which are hereby incorporated by reference for all purposes.

### BACKGROUND

The present application is directed to systems and methods for a turbocharged internal combustion engine.

Internal combustion engines have a cylinder block and at least one cylinder head, which are interconnected for forming the cylinder. In order to control the gas exchange, an internal combustion engine requires control elements—usually in the form of valves—and operating devices for operating these control elements. The valve operating mechanism which is required for moving the valves, including the valves themselves, is referred to as the valve gear. The cylinder head frequently serves for accommodating the valve gear.

In the course of the gas exchange, the expelling of the combustion gases is carried out via the exhaust openings of the cylinders and the filling of the combustion spaces, i.e. the intake of the fresh mixture or of the fresh air, is carried out via the inlet openings. It is the task of the valve gear to open or to close the inlet openings and exhaust openings at the right time, wherein a quick opening of flow cross sections which are as large as possible is aimed at in order to minimize the throttling losses in the incoming or discharging gas flows and to ensure a filling which is as efficient as possible of the combustion space with fresh mixture or to ensure an effective, i.e. complete, discharging of the exhaust gases. According to the prior art, the cylinders are therefore also frequently equipped with two or more inlet openings or exhaust openings.

The inlet ports, which lead to the inlet openings, and the exhaust ports, i.e. the exhaust gas pipes, which are connected to the exhaust openings, according to the prior art are integrated at least partially in the cylinder head. The exhaust gas pipes of the cylinders are usually brought together to form a common overall exhaust gas pipe or are brought together in groups to form two, or a plurality, of overall exhaust gas pipes. The bringing together of exhaust gas pipes to form an overall exhaust gas pipe is referred to in general as the exhaust gas manifold, wherein the portion of the overall exhaust gas pipe which lies upstream of a turbine arranged in the overall exhaust gas pipe is seen as being a part of the exhaust gas manifold.

Downstream of the manifolds, the exhaust gases, for the purpose of charging the internal combustion engine, are fed to the turbines of at least two exhaust gas turbochargers and, if necessary, to a system, or to a plurality of systems, for exhaust gas aftertreatment.

The advantages of an exhaust gas turbocharger, for example in comparison to a mechanical charger, are that no mechanical connection exists, or is necessary, for power transmission between the turbocharger and the internal combustion engine. Whereas a mechanical charger is driven entirely by energy received from the internal combustion engine and therefore reduces the available power and disadvantageously influences engine efficiency, the exhaust gas turbocharger utilizes the exhaust gas energy of the hot exhaust gases.

An exhaust gas turbocharger comprises a compressor and a turbine which are arranged on the same shaft, wherein the hot exhaust gas flow is fed to the turbine and is expanded in this turbine, with an output of energy, as a result of which the shaft is made to rotate. On account of the high rotational speed n_{T}, anti-friction bearings are preferably used for supporting the shaft. The energy which is delivered from the exhaust gas flow to the turbine, and ultimately to the shaft, is utilized for driving the compressor which is also arranged on the shaft. The compressor delivers and compresses the charge air which is fed to it, as a result of which a charging of the cylinders is achieved. If necessary, provision is made for charge-air cooling with which the compressed combustion air is cooled before entry into the cylinders.

The charging serves chiefly for increasing the power of the internal combustion engine. The air which is required for the combustion process is compressed in this case, as a result of which a greater mass of air can be fed to each cylinder per working cycle. As a result, the fuel mass, and therefore the average pressure, can be increased. Charging is a suitable means to increase the power of an internal combustion engine with an unaltered swept volume or to reduce the swept volume with the same power. In each case, the charging leads to an increase of the power-to-volume ratio and to a more favorable power-to-mass ratio. With the same vehicle boundary conditions, the load collective can thereby be shifted towards higher loads where the specific fuel consumption is lower.

The design of turbochargers for internal combustion engines frequently presents difficulties. Ideally, a turbocharger would provide the engine with an appreciable power increase in all rotational speed ranges. However, a sharp drop in torque is observed when a specified rotational speed of a turbocharged engine is not reached. This drop in torque is understandable when it is taken into account that the charging pressure ratio depends upon the turbine pressure ratio. A reduction of the engine rotational speed leads to a lower exhaust gas mass flow and therefore to a lower turbine pressure ratio. This has the result that the charging pressure ratio also reduces towards lower rotational speeds, which is equivalent to a drop in torque.

One known method for counteracting the drop in charging pressure in a turbocharged engine includes reducing turbine cross-sectional area to thereby increase turbine pressure ratio. However, rather than eliminating the drop in torque, this method causes the drop in torque to occur at lower rotational speeds. Moreover, limits are set on this procedure, i.e. on the reduction of turbine cross-sectional area, since the desired charging and power increase are to be as unrestricted as possible even at high rotational speeds, i.e. with large exhaust gas volumes.

Another known method for improving the torque characteristic of a turbocharged engine utilizes waste-gate turbines. When the volume of exhaust exceeds a critical value, a shut-off element is opened to direct some of the exhaust past the turbine or the turbine impeller by means of a bypass pipe (commonly referred to as “exhaust gas blow-off”). This procedure has the disadvantage that the charging performance is insufficient in the case of higher rotational speeds or larger exhaust gas volumes.

Yet another known method for improving the torque characteristic of a turbocharged internal combustion engine utilizes a plurality of parallel-disposed turbochargers, e.g. turbochargers with small cross-sectional areas, wherein an increasing number of turbines are engaged (e.g., by activating a cylinder exhaust valve connected to a turbine so that exhaust from the cylinder may flow through the turbine) with increasing exhaust gas volume. However, this method may be prohibitively expensive due to the costs associated with the separate housing for each turbine, especially because a turbine housing must withstand high thermal loads and thus is often made of costly materials, e.g. materials containing nickel.

### SUMMARY

To address the above issues and achieve various other advantages, the inventors herein have identified various example systems and methods for a turbocharged internal combustion engine. In one example, a turbocharged internal combustion engine comprises at least one cylinder head with at least two cylinders, each cylinder having at least two exhaust openings including at least one engageable opening and at least one non-engageable opening, an exhaust pipe adjoining each exhaust opening. Further, the engine comprises a first exhaust manifold including the exhaust pipes adjoining the engageable openings of at least two cylinders, the exhaust pipes of the first exhaust manifold merging inside the cylinder head to form a first overall exhaust pipe connected to a first turbine of a first turbocharger, and a second exhaust manifold including the exhaust pipes adjoining the non-engageable openings of the at least two cylinders, the exhaust pipes of the second exhaust manifold merging inside the cylinder head to form a second overall exhaust pipe connected to a second turbine of a second turbocharger. A first bypass pipe branches from the first exhaust manifold upstream of the first turbine, a second bypass pipe branches from the second exhaust manifold upstream of the second turbine, and the first and second turbines share a common turbine housing.

In this way, by using two separate exhaust manifolds (rather than an individual continuous piping system upstream of the turbines), the operating behavior of the engine is improved. For example, the piping volume upstream of the second turbine, through which exhaust gas continuously flows, is reduced, which is advantageous at low loads or rotational speeds (e.g. with small volumes of exhaust gas) especially with regard to the response behavior. Further, by using two separate exhaust manifolds in accordance with the above example, the length and the volume of the pipes of the exhaust system are reduced, thereby reducing the weight of the engine and enabling a more compact construction. The reduced weight of the engine also advantageously lowers the cost of the engine.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 is a schematic diagram of an example turbocharged internal combustion engine.

FIG. 2 is a partial schematic diagram of a second example turbocharged internal combustion engine.

FIG. 3 provides cross-sectional views of a connecting passage and an exhaust pipe which may be included in the turbocharged internal combustion engines of FIGS. 1 and 2.

FIG. 4 depicts an example operating method for a turbocharged internal combustion engine, to be used in conjunction with the example engines depicted in FIGS. 1 and 2.

FIG. 5 depicts an example control method for a turbocharged internal combustion engine, to be used in conjunction with the method of FIG. 4.

### DETAILED DESCRIPTION

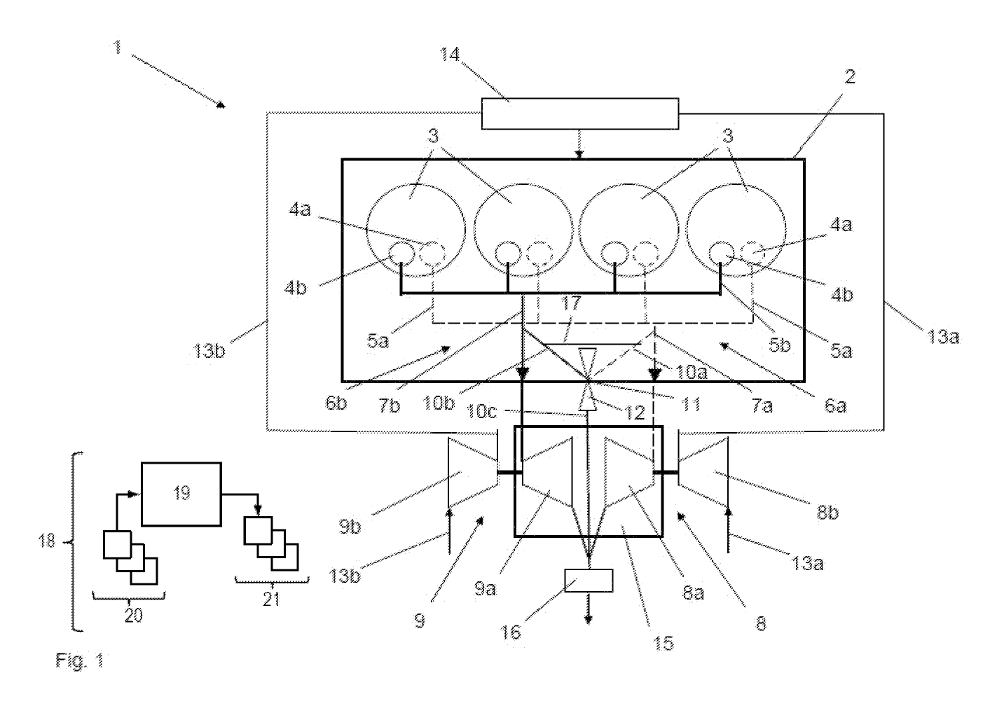

FIG. 1 schematically shows an example turbocharged internal combustion engine 1. Within the scope of the present invention, the term “internal combustion engine” embraces particularly Otto engines, but also diesel engines and hybrid internal combustion engines.

Engine 1 is a four-cylinder in-line engine in which cylinders 3 are arranged along the longitudinal axis of cylinder head 2, i.e. in line. Each cylinder 3 has two exhaust openings 4a, 4b, wherein an exhaust gas pipe 5a, 5b, for discharging the exhaust gases from the cylinder 3, adjoins each exhaust opening 4a, 4b. While FIG. 1 depicts one cylinder head, in some examples engine 1 may include more than one cylinder head. For example, the engine may include two cylinder heads if a plurality of cylinders are arranged in a manner in which they are split into two cylinder banks. Similarly, while the cylinder head depicted in FIG. 1 has four cylinders, each cylinder head may include two or more cylinders.

Engine 1 is further equipped with two exhaust gas turbochargers 8, 9. Each exhaust gas turbocharger 8, 9 comprises a turbine 8a, 9a and a compressor 8b, 9b which are arranged on the same shaft. The first turbine 8a and the second turbine 9a have a common turbine housing 15 which in the present case is arranged at a distance from the cylinder head 2. The hot exhaust gas is expanded in the turbines 8a, 9a, with the output of energy, and the compressors 8b, 9b compress the charge air which, via intake lines 13a, 13b and a plenum 14, is fed to the cylinders 3, as a result of which the charging of the internal combustion engine 1 is achieved.

In accordance with the invention, the turbine of the first exhaust gas turbocharger, i.e. the first turbine, is designed as an engageable turbine, and the exhaust openings of the exhaust gas pipes which go to this turbine, and correspond thereto, are constructed as engageable exhaust openings. Only in the case of larger exhaust gas volumes are the engageable exhaust openings opened in the course of the gas exchange and, as a result, the first turbine is activated, i.e. subjected to admission of exhaust gas. For example, as shown in FIG. 1, at least one exhaust opening of each cylinder 3 is formed in each case as an engageable exhaust opening 4a (dashed lines) which in the course of the gas exchange is opened only when the exhaust gas volume exceeds a first predetermined exhaust gas volume. As a result, the first turbine 8a, which is arranged downstream, is activated, i.e. is subjected to admission of exhaust gas.

Additionally, at least one other exhaust opening of each cylinder is formed as a non-engageable exhaust opening 4b (continuous lines). The non-engageable exhaust openings may remain open at all times, e.g. whether or not a certain exhaust gas volume is present.

Endeavors are made to arrange the turbines as close as possible to the exhaust, i.e. to the exhaust openings of the cylinders, in order to optimally utilize the exhaust gas enthalpy of the hot exhaust gases, which is determined essentially by the exhaust gas pressure and the exhaust gas temperature, and to ensure a fast response behavior of the turbochargers. Towards this end, attempts are made to minimize the thermal inertia and the volume of the piping system between the exhaust openings on the cylinders and the turbines, which can be achieved by reducing the mass and the length of the exhaust gas pipes.

The exhaust gas pipes are brought together inside the cylinder head, as a result of which the length or the volume of the piping system upstream of the turbines may be significantly shortened or reduced. This measure enables a compact type of construction of the internal combustion engine, wherein in addition to the number of components and the weight of the engine being reduced, the costs, especially the assembly costs and stand-by costs, are also reduced. The compact type of construction furthermore allows a compact packaging of the entire drive unit in the engine compartment.

Accordingly, the exhaust gas pipes of at least two cylinders are brought together in a grouped manner such that from each of these cylinders at least one exhaust gas pipe leads to the first turbine and at least one exhaust gas pipe leads to the second turbine. In the example shown in FIG. 1, the exhaust gas pipes 5a of the engageable exhaust openings 4a of all the cylinders 3, forming a first exhaust gas manifold 6a, come together to form a first overall exhaust gas pipe 7a which is connected to the turbine 8a of the first exhaust gas turbocharger 8 (dashed lines). The exhaust gas pipes 5b of the other exhaust openings 4b of all the cylinders 3, forming a second exhaust gas manifold 6b, come together to form a second overall exhaust gas pipe 7b which is connected to the turbine 9a of the second exhaust gas turbocharger 9 (continuous lines). In other examples, the exhaust gas pipes of all the cylinders of a cylinder head do not have to come together to form two overall exhaust gas pipes; rather, only the exhaust gas pipes of at least two cylinders need to be grouped in the described manner. In the example shown in FIG. 1, the exhaust gas pipes 5a, 5b come together inside the cylinder head 2 to form overall exhaust gas pipes 7a, 7b.

In comparison to embodiments in which an individual continuous piping system is provided upstream of the turbines, the operating behavior of the internal combustion engine, especially in the case of low exhaust gas flows, is improved as a result of the previously described grouping, i.e. as a result of using two separate exhaust gas manifolds. This inter alia is also advantageous because the piping volume upstream of the second turbine, through which exhaust gas continuously flows, is reduced, which is advantageous at low loads or rotational speeds, e.g. with small volumes of exhaust gas, especially with regard to the response behavior.

As is evident from FIG. 1, both turbines 8a, 9a are designed as waste-gate turbines 8a, 9a in which exhaust gas can be blown off via bypass pipes 10a, 10b, 10c. The first turbine 8a is equipped with a first bypass pipe 10a which branches from the overall exhaust gas pipe 7a of the first exhaust gas manifold 6a upstream of the first turbine 8a, and the second turbine 9a is equipped with a second bypass pipe 10b which branches from the overall exhaust gas pipe 7b of the second exhaust gas manifold 6b upstream of the second turbine 9a.

The first and the second bypass pipes 10a, 10b are integrated into the cylinder head 2, as a result of which the risk of exhaust gas leakage is reduced. First and second bypass pipes 10a, 10b further form a junction point 11, and come together to form a common bypass pipe 10c. In this example, the common bypass pipe 10c is integrated in the common turbine housing 15 and together with the two overall exhaust gas pipes 7a, 7b leads to a catalyst 16 in which the exhaust gas is aftertreated. In other examples, the common bypass pipe may lead into one of the two overall exhaust gas pipes downstream of the turbines, rather than merging with both of them as depicted in FIG. 1.

As discussed above, the first bypass pipe branches from the first overall exhaust pipe in the example shown in FIG. 1. Since the total exhaust gas of the exhaust openings which are associated with the first exhaust gas manifold passes through the first overall exhaust gas pipe, the total exhaust gas can theoretically also be blown off via the first bypass pipe. This also applies to the second bypass pipe, which branches from the second overall exhaust gas pipe in the example shown in FIG. 1.

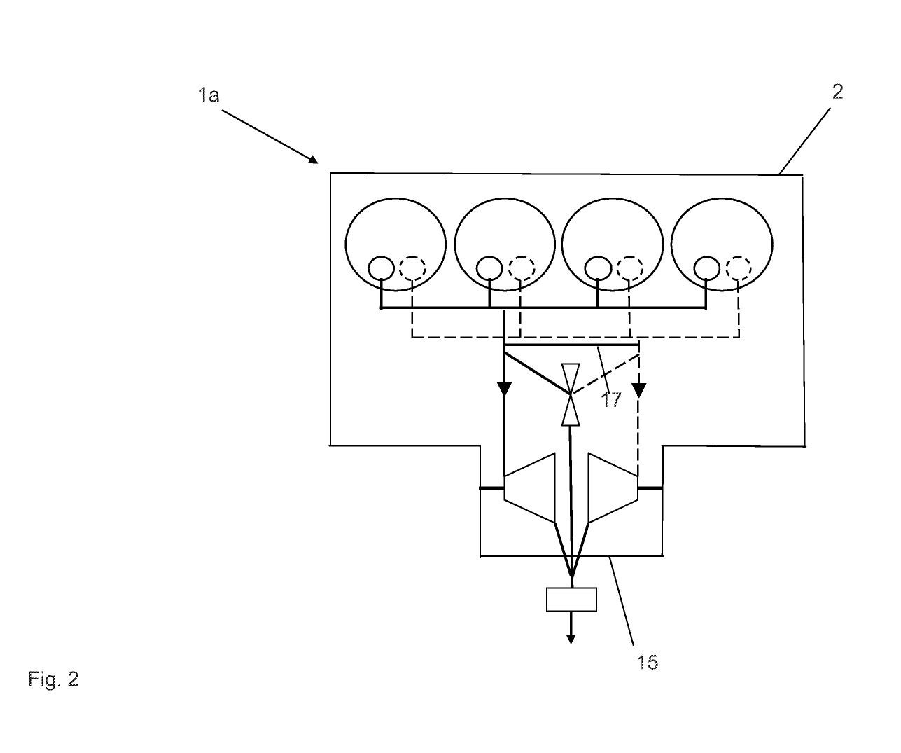

As shown in FIG. 1, the first bypass pipe and/or the second bypass pipe are, or is, integrated at least partially into the cylinder head. Further, in some examples, such as the example shown in FIG. 2, the first bypass pipe and/or the second bypass pipe are, or is, integrated at least partially in the common turbine housing. Integrating the various components in this way advantageously reduces the number of components and the costs associated therewith, and further reduces the risk of leakage of exhaust gas.

At the junction point 11, provision is made for a shut-off element 12 which is adjustable between an open position and a closed position. The shut-off element 12 in the closed position isolates the two bypass pipes 10a, 10b from the common bypass pipe 10c and in the open position connects these to the common bypass pipe 10c. In this way, both bypass pipes may be opened and closed with only one shut-off element. Numerous advantages may be associated with opening and closing both bypass pipes with only one shut-off element. For example, a shut-off element for a waste-gate turbine is thermally highly loaded as a result of the impingement of the hot exhaust gas, and therefore is produced using costly materials which can withstand high thermal loads. As such, reducing the number of shut-off elements required for exhaust blow-off may achieve cost savings. Further, the controlling of a shut-off element is comparatively costly and, when using a barometric cell for charging pressure or exhaust gas pressure control, there is a corresponding space requirement for the barometric cell and the associated mechanism. The latter in particular opposes a compact type of construction or a compact packaging. In this respect, it may be advantageous to control the two bypass pipes with only one shut-off element.

Alternatively, in other examples, it may be advantageous if the first bypass pipe and the second bypass pipe are equipped in each case with a shut-off element and, if necessary, only come together downstream of the turbines.

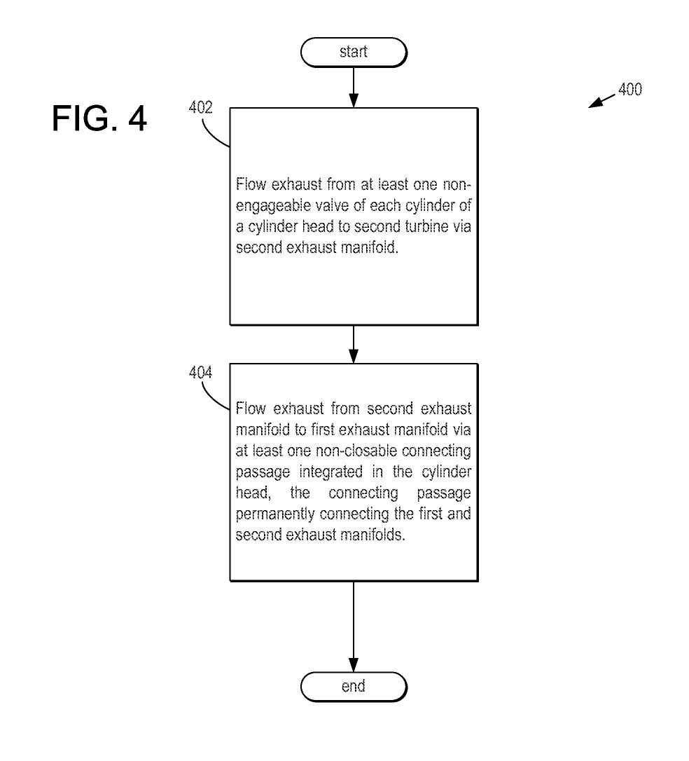

In some examples, in the closed position of the shut-off element at least one non-closable connecting passage remains. A non-closable connecting passage 22, which permanently interconnects the first and second exhaust exhaust manifolds, will be discussed below with reference to FIGS. 2 and 4. Herein, a non-closable connecting passage which permanently interconnects the two bypass pipes specifically will be referred to as a “transfer” passage. Such a transfer passage may provide an improved operating behavior of the engageable first turbine. As shown in FIG. 1, engine 1 includes transfer passage 17 interconnecting the first and second bypass pipes.

As shown in FIG. 1, the two parallel-disposed turbines may share a common turbine housing 15. The one common housing is less material intensive, i.e. requires less material than two separate turbine housings, which leads to weight savings. Moreover, the material—frequently with nickel content—which is used for the thermally highly loaded turbine housing is comparatively cost intensive, especially in comparison to the aluminum material which is frequently used for the cylinder head. In addition to the high cost of thermally highly loadable material itself, the machining of the such material is also more time consuming and gives rise to more costs in the course of the production of a housing relative to other materials. As such, the use of a common turbine housing leads to a cost advantage both with regard to materials and production costs. And, in addition to the aforesaid advantages, the accommodating of the two parallel-disposed turbines in a common housing advantageously allows a compact packaging of the entire drive unit.

In some examples, the common turbine housing comprises at least one cast part. Producing the housing or parts of the housing by the casting method advantageously facilitates the forming of the complex shape of the housing. Further, aluminum may be used for the housing, as a result of which a particularly high weight savings may be achieved. The housing can also be produced from gray cast iron or from other cast materials.

In some examples, the common turbine housing and the at least one cylinder head constitute separate components which are interconnected in a frictionally-engaging, form-fitting and/or materially bonding manner. A modular construction, in which the turbine housing and the cylinder head constitute separate components and are interconnected in the course of the assembly, has the advantage that, on the one hand, the turbine can be combined with other cylinder heads and, on the other hand, the cylinder head can be combined with other turbines according to the modular principle. The diverse usability of a component as a rule increases the piece number, as a result of which the unit costs are lowered. Moreover, the costs, which accrue if the turbine or the cylinder head is to be exchanged, i.e. to be replaced, as a result of a defect, are lowered. The modular construction also allows the retrofitting of internal combustion engines or of existing concepts which are already on the market, i.e. designing an internal combustion engine according to the invention using an already existing cylinder head.

Alternatively, at least parts of the common turbine housing may be formed integrally with the at least one cylinder head so that the cylinder head and at least one part of the turbine housing form a monolithic component. For example, FIG. 2 depicts an embodiment wherein the cylinder head and the entire turbine housing are formed integrally as a monolithic component. In principle, the necessity of a gastight, thermally highly loadable connection of cylinder head and turbine housing is dispensed with as a result of the monolithic (one-piece) design, which offers cost savings. Similarly, a monolithic design reduces the risk of exhaust gas undesirably escaping into the environment as a result of a leakage. Further, the monolithic type of construction leads to a reduction in the number of components and to a more compact type of construction.

With a monolithic design, an arrangement of the turbines which is particularly close to the engine can be realized because access for installation tools no longer has to be provided, which simplifies the constructional layout of the turbine housing and allows an optimization with regard to the operation of the turbines. The housing can be designed with a comparatively small volume and the impellers of the turbines can be arranged in proximity to the inlet region, which is not readily possible when taking installation access into consideration.

Advantageously, in some examples the shafts of the exhaust gas turbochargers together with the preassembled turbine impellers and compressor impellers are fitted as a preassembled sub-assembly—for example in the form of a cartridge—in the turbine housing or in a turbocharger housing. This shortens the installation time appreciably. In this case, the housing accommodates not only turbine components but also parts of the compressor.

Although not depicted in FIG. 1, in some examples, the turbines are equipped with a cooling system. Turbocharged internal combustion engines such as engine 1 may be subject to higher thermal loads than naturally-aspirated engines, in which case higher demands are made on the cooling system of a turbocharged engine relative to a naturally-aspirated engine. The cooling system may be an air cooling system or a liquid cooling system, for example. On account of the significantly higher thermal capacity of liquids compared with air, significantly greater amounts of heat can be dissipated with the liquid cooling system than is possible with an air cooling system. A liquid cooling system requires the equipping of the internal combustion engine, i.e. of the cylinder head or the cylinder block, with an integrated coolant jacket, i.e. the arranging of coolant passages which direct the coolant through the cylinder head or cylinder block. The heat is already yielded inside the component to the coolant which may comprise water mixed with additives. The coolant is delivered in this case by means of a pump which is arranged in the cooling circuit so that the coolant circulates inside the coolant jacket. The heat which is yielded to the coolant is discharged in this way from the inside of the head or block and is extracted again from the coolant in a heat exchanger.

In examples where the turbines are equipped with a liquid cooling system, further advantages ensue from the use of a common turbine housing since only one housing has to be provided with a coolant jacket or coolant passage. The use of cost-intensive materials, for example with nickel content, is then usually no longer necessary or greatly reduced. This lowers the production costs as well, because the machining costs of thermally highly loadable materials tend to be higher than for other materials, as discussed above. If the turbine housing and the cylinder head are liquid cooled and the coolant jacket, which is integrated in the turbine housing, is to be supplied with coolant via the cylinder head, an integral design of the two components is extremely advisable since additional pipes can be dispensed with when connecting the two cooling circuits or coolant jackets. In this case, a coolant jacket which is integrated in the cylinder head can also form the coolant jacket which is provided in the housing so that a connection of two originally independent coolant jackets as such no longer exists or is no longer to be designed. With regard to the coolant circuits or to the connecting of the coolant jackets and the leakage of coolant, what has been said already with regard to the exhaust gas flow similarly applies.

While not shown, an oil supply pipe can also be implemented, i.e. the supply of the turbines with oil for the purpose of lubricating the turbine shafts can be carried out via a pipe which is integrated into the cylinder head and the housing. An external pipe for the oil supply, and therefore the designing and sealing of the connecting points between pipe and housing or between pipe and cylinder head, may be unnecessary. Advantageously, the oil can be extracted from the cylinder head and fed to the housing or to the turbines without there being the risk of a leakage.

Engine 1 may further include control system 18. Control system 18 is shown receiving information from a plurality of sensors 20 and sending control signals to a plurality of actuators 21. Sensors 20 may include pressure, temperature, air/fuel ratio, and composition sensors, for example. Actuators 21 may include valves which open and close the engageable exhaust openings. For example, the engine may be equipped with an at least partially variable valve gear, preferably a fully variable valve gear, for operating the engageable exhaust openings. The valve gear may include actuators 21 to operate the engageable exhaust openings. The control system 18 may include a controller 19. The controller may receive input data from various sensors, process the input data, and trigger various actuators in response to the processed input data based on instruction or code programmed therein corresponding to one or more routines. For example, controller 19 may receive input data from sensors relating and process the data to determine a current exhaust gas volume, and then trigger actuators such as actuators operating the engageable exhaust openings based on the volume.

FIG. 2 is a partial schematic diagram of a second example turbocharged internal combustion engine 1a. Aside from two differences, engine 1a is identical to engine 1 of FIG. 1.

The first difference between engines 1 and 1a is that in engine 1a, cylinder head 2 and common turbine housing 15 are formed integrally. As discussed above, this monolithic type of construction advantageously leads to a reduction in the number of components and to a more compact construction. In other examples, only part of common turbine housing 15 may be formed integrally with cylinder head 2, or common turbine housing 15 and cylinder head 2 may be entirely separate.

The second difference between engines 1 and 1a is that engine 1a includes non-closable connecting passage 22 instead of transfer passage 17. In engine 1a, connecting passage 22 permanently interconnects the first and second exhaust manifolds upstream of the first and second bypass pipes. While FIG. 2 includes a connecting passage but no transfer passage, it will be appreciated that in some examples both a connecting passage and a transfer passage may be included in the engine. In other examples, a connecting passage may permanently interconnect the first and second exhaust manifolds at a different location (e.g., downstream of the first and second bypass pipes), or the engine may include multiple connecting passages (some of which may be transfer passages), or no connecting passages.

Connecting passage 22 fulfills the same function as transfer passage 17 described above, specifically to feed exhaust gas to the first turbine even in the deactivated state in order to ensure a minimum rotational speed, as described below with respect to FIG. 4.

With regard to the function of the two described types of passages, advantages exist in examples in which each passage constitutes a throttling point which leads to a pressure drop in the exhaust gas flow passing through the passage. In this way, it is ensured that only a small exhaust gas volume passes through the passage(s), specifically just enough exhaust gas to maintain a certain minimum rotational speed of the turbine shaft.

A connecting passage is to be dimensioned in proportion to its function, i.e. is to be constructed smaller than, for example, an exhaust gas pipe which adjoins an exhaust opening and serves for supplying the turbine with sufficient exhaust gas with as little loss as possible. For example, it may be advantageous when the smallest cross-sectional area A_{Quer,V} or A_{Quer,K} of the passage is smaller than the smallest cross-sectional area A_{Quer,Ex} of an exhaust gas pipe (e.g., an exhaust pipe 5a, 5b or an overall exhaust pipe 7a, 7b). The flow cross-sectional area of a pipe or of a passage is the parameter which has significant influence upon the throughput, i.e. upon the exhaust gas volume directed through the passage per unit of time. For comparison purposes, reference is made according to the invention to the flow cross section which is perpendicular to the center thread of the stream.

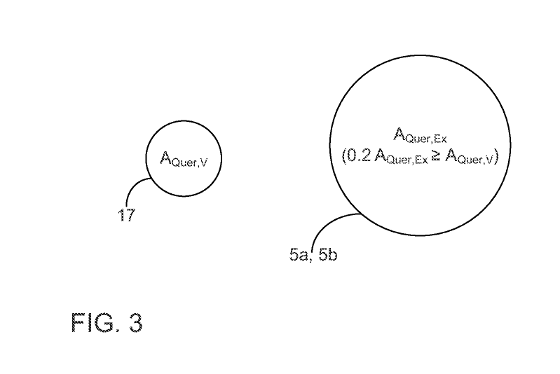

It may be advantageous when A_{Quer,K} or A_{Quer,V}≦0.2 A_{Quer,Ex} is applicable. For example, FIG. 3 illustrates such a relationship between the cross-sectional areas of a passage and an exhaust pipe, where A_{Quer,V}≦0.2 A_{Quer,Ex}. Further, it may be advantageous in examples in which A_{Quer,K} or A_{Quer,V}≦0.1 A_{Quer,Ex}, preferably A_{Quer,K} or A_{Quer,V}≦0.05 A_{Quer,Ex}, is applicable.

In the case of engines in which a connecting passage is provided, advantages exist in examples which are characterized in that the connecting passage branches from an exhaust gas pipe of the second exhaust gas manifold and connects that exhaust gas pipe to an exhaust gas pipe of the first exhaust gas manifold, for example, or to the overall exhaust gas pipe of the first exhaust gas manifold. Since only small exhaust gas volumes are to be transferred via the connecting passage into the first manifold, as detailed below with respect to FIG. 4, supplying the connecting passage with exhaust gas via the exhaust gas pipe of an individual exhaust opening is basically sufficient. However, alternatively, it may be advantageous if the at least one connecting passage interconnects the two overall exhaust gas pipes of the first and second exhaust manifolds. With such an adjacent arrangement of the two overall exhaust gas pipes to each other, this embodiment shortens the length of the connecting passage.

If a connecting passage is provided, further advantages exist in examples in which the connecting passage is integrated into the cylinder head. As a result, the risk of a leakage of exhaust gas is eliminated. Moreover, the design of a compact type of construction of the internal combustion engine is aided. Compared with embodiments with an external passage, fastening means and additional sealing elements are dispensed with.

FIG. 4 schematically shows an example operating method 400 that may be used in conjunction with engine 1.

At 402, method 400 includes flowing exhaust from at least one non-engageable opening of each cylinder of a cylinder head to a second turbine via a second exhaust manifold integrated in the cylinder head.

At 404, method 400 includes flowing exhaust from the second exhaust manifold to the first exhaust manifold via at least one non-closable connecting passage integrated in the cylinder head and permanently connecting the first and second exhaust manifolds. The connecting passage may interconnect an exhaust pipe of the second exhaust manifold and an exhaust pipe of the first exhaust manifold, e.g. connecting passage 22 of FIG. 2. Alternatively, the connecting passage may interconnect the first and second bypass passages of the first and second exhaust manifolds, e.g. transfer passage 17 of FIG. 1.

In this way, method 400 advantageously ensures that even with low exhaust gas volumes when the engageable exhaust openings are routinely deactivated (i.e., when exhaust does not flow from the engageable openings to the first turbine via the first exhaust manifold), a connecting passage allows some of the exhaust gas to transfer from the second exhaust gas manifold into the first exhaust gas manifold so that the first turbine, via the second exhaust gas manifold and the connecting passage, is also subjected to admission of exhaust gas when the engageable exhaust openings are in the deactivated, i.e. shut-down, state. In some examples, just enough exhaust gas is to be fed to the first turbine via the connecting passage for the turbine shaft not to fall below a minimum rotational speed n_{T}. The maintaining of a certain minimum rotational speed prevents or reduces the build-up of the hydrodynamic lubricating film in the anti-friction bearing of the shaft of the first turbocharger. As such, the measure of feeding a small exhaust gas volume to the first turbine even in the deactivated state of the engageable exhaust openings has an advantageous effect upon the wear and the durability of the first turbocharger. Moreover, the response behavior of the first turbine, or of the charging overall, is improved because the first turbine, when activated, is accelerated from a higher rotational speed. Accordingly, a torque which is required by the driver can be achieved comparatively quickly, i.e. with only a short delay.

The connecting passage is to provide only a small exhaust gas volume, that is to say enough exhaust gas in order to ensure a minimum rotational speed n_{T} of the shaft, and is to be geometrically correspondingly dimensioned, as described above with respect to FIG. 3. It is not the task of the first turbine in the deactivated state of the engageable exhaust openings to contribute to the build-up of the charging pressure. The provision of the exhaust gas volume which is required for this is not the task of the connecting passage, but rather that of the first exhaust gas manifold when the engageable exhaust openings are activated.

In principle, the connecting passage is of significance when the engageable exhaust openings are deactivated, e.g. in the case of low exhaust gas volumes when as a rule the shut-off element, which is arranged at the junction point, is also deactivated, i.e. closed. In some examples, it may be advantageous for the shut-off element to also form the connecting passage when transferring into the closed position. In this case, the connecting passage would be a transfer passage consisting of the first and second bypass pipes and the junction point, rather than a separate pipe interconnecting the two bypass pipes such as transfer passage 17 as shown in FIG. 1.

If there is no provision for a connecting passage, it can be disadvantageous that the internal combustion engine is equipped with two separate exhaust gas manifolds, which are isolated from each other, and engageable exhaust openings. The first turbine is then completely cut off from the exhaust gas flow in the deactivated state of the engageable exhaust openings, i.e. no exhaust gas at all is fed to the shut-down first turbine. This results from the use of a separate exhaust gas manifold and non-opening of the engageable exhaust openings in this operating state. As a result of the absent inflow of exhaust gas, the rotational speed of the first turbine is significantly reduced when deactivated. The hydrodynamic lubricating film in the shaft bearing breaks down or disintegrates. This leads to impairment of the response behavior of the first turbine when activated.

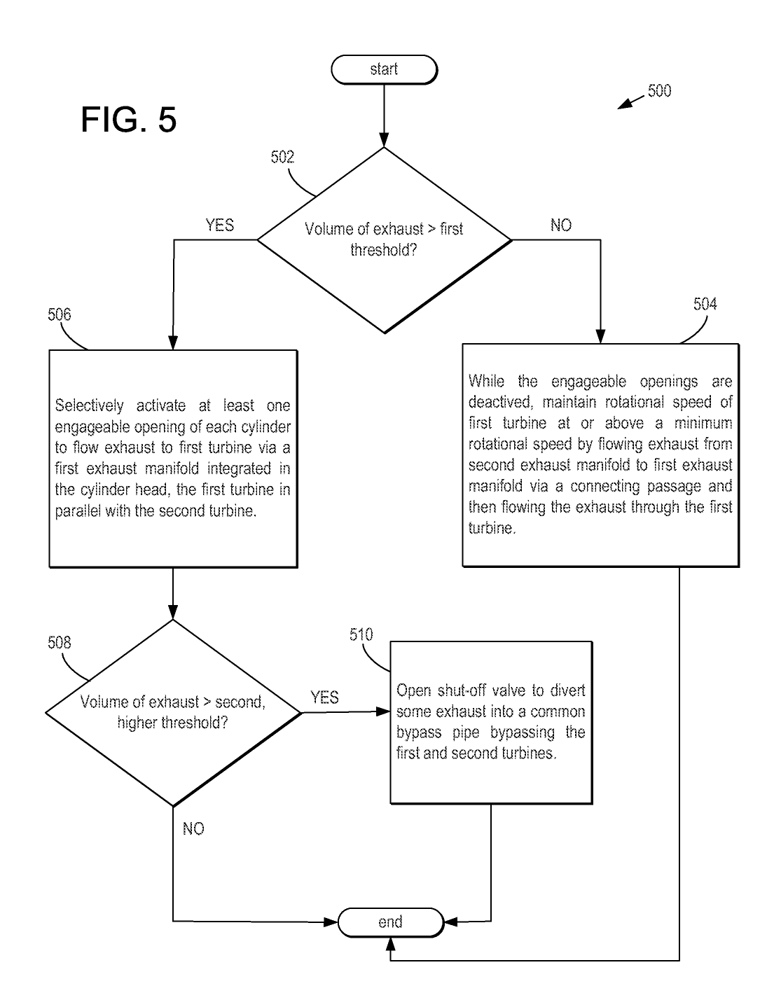

FIG. 5 schematically shows an example control method 500 that may be used in conjunction with method 400.

At 502, method 500 includes determining whether a volume of exhaust exceeds a first threshold.

In the case of a non-charged internal combustion engine, the exhaust gas volume corresponds approximately to the rotational speed and/or to the load of the internal combustion engine, in fact as a function of the load control which is used. In the case of a traditional Otto engine with quantity control, the exhaust gas volume increases with increasing load even at constant rotational speed whereas the exhaust gas volume in the case of traditional diesel engines with quality control is only dependent upon rotational speed because with a load change and at constant rotational speed the mixture composition does not vary the mixture volume. If the internal combustion engine according to the invention is based on quantity control, in which the load is controlled via the volume of fresh mixture, the exhaust gas volume can exceed a first threshold (i.e., the relevant, predetermined exhaust gas volume) even at constant rotational speed if the load of the internal combustion engine exceeds a predetermined load since the exhaust gas volume correlates with the load, wherein the exhaust gas volume increases as load increases and reduces as load decreases. If, however, the internal combustion engine is based on quality control, in which the load is controlled via the composition of the fresh mixture and the exhaust gas volume alters almost exclusively with the rotational speed, i.e. is proportional to the rotational speed, the exhaust gas volume exceeds the first threshold independently of the load if the rotational speed of the internal combustion engine exceeds a predetermined rotational speed.

The internal combustion engine according to the invention is a charged internal combustion engine, so that the charging pressure on the intake side, which can alter with the load and/or with the rotational speed and has an influence upon the exhaust gas volume, is additionally to be taken into consideration. The previously explained relationships regarding the exhaust gas volume and the load or rotational speed consequently apply in this general form only to a limited extent. Therefore, method 500 is based in the most general sense upon the exhaust gas volume and not upon the load or rotational speed.

If the answer at 502 is NO, method 500 continues to 504. At 504, method 500 includes, while the engageable openings are deactivated, maintaining a rotational speed of the first turbine at or above a minimum rotational speed by flowing exhaust from the second exhaust manifold to the first exhaust manifold via the connecting passage and then flowing the exhaust through the first turbine. After 504, method 500 ends.

Otherwise, if the answer at 502 is YES, method 500 continues to 506. At 506, method 500 includes selectively activating at least one engageable exhaust opening of each cylinder to flow exhaust to the first turbine via a first exhaust manifold integrated in the cylinder head, the first turbine in parallel with the second turbine. The activating of the engageable exhaust openings is equivalent to the engaging of the first turbine. A previous accelerating of the first turbine via a connecting passage remains unaffected by it, i.e. is possible independently of it.

In other examples, it may be advantageous if the engageable exhaust openings are activated as soon as the exhaust gas volume exceeds the first threshold and for a predetermined time span Δt₁ is larger than the first threshold. The introduction of an additional condition for engaging the first turbine is to prevent an excessively frequent changeover, especially an activation of the engageable exhaust openings, if the exhaust gas volume exceeds the first threshold only for a short time and then falls again, or fluctuates around the first threshold, without which exceeding of the first threshold would justify or necessitate engagement of the engageable exhaust openings and thus of the first turbine.

For the aforesaid reasons, advantages also exist in method variants in which the engageable exhaust openings are deactivated as soon as the exhaust gas volume falls short of the first threshold and for a predetermined time span Δt₂ is smaller than the first threshold.

After 506, method 500 continues to 508. At 508, method 500 includes determining whether the volume of exhaust exceeds a second, higher threshold. The second, higher threshold is higher than the first threshold (i.e., the second threshold represents a larger volume of exhaust gas relative to the first threshold).

If the answer at 508 is NO, method 500 ends. Otherwise, if the answer at 508 is YES, method 500 continues to 510. At 510, method 500 includes opening a shut-off valve to divert some exhaust into a common bypass pipe bypassing the first and second turbines. As described above with respect to FIGS. 1 and 1a, the shut-off valve may be arranged at a junction point of a first bypass pipe branching from the first exhaust manifold upstream of the first turbine and a second bypass pipe branching from the second exhaust manifold upstream of the second turbine. In this way, exhaust gas blow-off may be initiated as soon as the exhaust gas volume exceeds the second threshold.

In another example, it may be advantageous to open the shut-off valve to initiate exhaust blow-off as soon as the exhaust gas volume exceeds the second threshold and for a predetermined time span Δt₃ is larger than the second threshold.

If the first and second bypass pipes are interconnected upstream of the turbines, this enables method variants in which the first turbine is accelerated shortly before activation of the engageable exhaust openings by opening the bypass pipes (e.g., via the shut-off valve), wherein exhaust gas flows, i.e. is transferred, from the second exhaust manifold, via the second and first bypass pipes, into the first exhaust manifold. In this case, the first and second bypass pipes together form a transfer passage.

Advantages also exist in method variants in which at least one bypass pipe is closed as soon as the exhaust gas volume falls short of a predetermined exhaust gas volume (e.g., falls below the second threshold) and for a predetermined time span Δt₄ is smaller than this predetermined exhaust gas volume.

After 510, method 500 ends. However, it is to be understood that method 500 may be repeatedly performed such that if the exhaust gas volume falls short of the first threshold again, the engageable exhaust openings are deactivated again and, along with these, the engageable first turbine is deactivated.

It will be appreciated that methods 400 and 500 are provided by way of example, and thus, are not meant to be limiting. Therefore, it is to be understood that methods 400 and 500 may include additional and/or alternative steps than those illustrated in FIGS. 4 and 5, respectively, without departing from the scope of this disclosure. Further, it will be appreciated that methods 400 and 500 are not limited to the order illustrated; rather, one or more steps may be rearranged or omitted without departing from the scope of this disclosure.

Note that the example control and estimation routines included herein can be used with various engine and/or vehicle system configurations. The specific routines described herein may represent one or more of any number of processing strategies such as event-driven, interrupt-driven, multi-tasking, multi-threading, and the like. As such, various steps, operations, or functions illustrated may be performed in the sequence illustrated, in parallel, or in some cases omitted Likewise, the order of processing is not necessarily required to achieve the features and advantages of the example embodiments described herein, but is provided for ease of illustration and description. One or more of the illustrated steps or functions may be repeatedly performed depending on the particular strategy being used. Further, the example routines may graphically represent code to be programmed into the computer readable storage medium in the controller.

The various ducts and passages referred to herein can encompass various forms of conduits, passages, connections, etc., and are not limited to any specific cross-sectional geometry, material, length, etc.

It will be appreciated that the configurations and routines disclosed herein are exemplary in nature, and that these specific embodiments are not to be considered in a limiting sense, because numerous variations are possible. For example, the above technology can be applied to V-6, I-4, I-6, V-12, opposed 4, and other engine types. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A turbocharged internal combustion engine, comprising:
at least one cylinder head with at least two cylinders, each cylinder having at least two exhaust openings including at least one engageable opening and at least one non-engageable opening, an exhaust pipe adjoining each exhaust opening;
a first exhaust manifold including the exhaust pipes adjoining the engageable openings of at least two cylinders, the exhaust pipes of the first exhaust manifold merging inside the cylinder head to form a first overall exhaust pipe connected to a first turbine of a first turbocharger;
a second exhaust manifold including the exhaust pipes adjoining the non-engageable openings of the at least two cylinders, the exhaust pipes of the second exhaust manifold merging inside the cylinder head to form a second overall exhaust pipe connected to a second turbine of a second turbocharger;
a first bypass pipe branching from the first exhaust manifold upstream of the first turbine; and
a second bypass pipe branching from the second exhaust manifold upstream of the second turbine;
wherein the first turbine and the second turbine share a common turbine housing.

2. The engine of claim 1, wherein at least part of the common turbine housing is formed integrally with the cylinder head.

3. The engine of claim 1, wherein the first and second bypass pipes meet at a junction point to form a common bypass pipe integrated at least partially in the common turbine housing, and wherein a shut-off element arranged at the junction point is adjustable between an open position connecting the two bypass pipes to the common bypass pipe and a closed position isolating the two bypass pipes from the common bypass pipe.

4. The engine of claim 1, wherein the common turbine housing comprises at least one cast part.

5. The engine of claim 1, wherein the first and second bypass pipes are integrated at least partially into the common turbine housing and/or the cylinder head.

6. The engine of claim 1, wherein the first and second exhaust manifolds are permanently interconnected upstream of the first and second turbines via at least one non-closable connecting passage integrated into the cylinder head, and wherein a smallest cross-sectional area A_{Quer,V} of the connecting passage is smaller than a smallest cross-sectional area A_{Quer,Ex} of an exhaust pipe.

7. The engine of claim 6, wherein A_{Quer,V} is less than or equal to 0.2 A_{Quer,Ex}.

8. The engine of claim 6, wherein the connecting passage is a transfer passage connecting the first and second bypass pipes.

9. A method for a turbocharged engine, comprising:
flowing exhaust from at least one non-engageable opening of each cylinder of a cylinder head to a second turbine via a second exhaust manifold integrated in the cylinder head; and
selectively activating at least one engageable opening of each cylinder to flow exhaust to a first turbine via a first exhaust manifold integrated in the cylinder head, the first turbine in parallel with the second turbine.

10. The method of claim 9, wherein selectively activating at least one engageable opening of each cylinder comprises activating the at least one engageable opening of each cylinder when a volume of exhaust exceeds a first threshold.

11. The method of claim 10 further comprising, when the volume of exhaust exceeds a second, higher threshold, opening a shut-off valve arranged at a junction point of a first bypass pipe branching from the first exhaust manifold upstream of the first turbine and a second bypass pipe branching from the second exhaust manifold upstream of the second turbine to divert some exhaust into a common bypass pipe bypassing the first and second turbines.

12. The method of claim 9, further comprising flowing exhaust from the second exhaust manifold to the first exhaust manifold via at least one non-closable connecting passage integrated in the cylinder head, the connecting passage permanently connecting the first and second exhaust manifolds.

13. The method of claim 12, wherein a smallest cross-sectional area of the connecting passage is smaller than a smallest cross-sectional area of an exhaust pipe.

14. The method of claim 13 further comprising, while the engageable openings are deactivated, maintaining a rotational speed of the first turbine at or above a minimum rotational speed by flowing exhaust from the second exhaust manifold to the first exhaust manifold via the connecting passage and then flowing the exhaust through the first turbine.

15. A system for an engine, comprising:
a cylinder head with at least two cylinders;
at least two exhaust openings per cylinder, at least one of which is engageable;
a first exhaust manifold integrated in the cylinder head and connecting the engageable openings with a first turbocharger turbine;
a second, separate exhaust manifold integrated in the cylinder head and connecting the non-engageable openings with a second turbocharger turbine in parallel with the first turbine.

16. The system of claim 15, wherein the first and second turbines share a common turbine housing.

17. The system of claim 16, wherein at least part of the common turbine housing is formed integrally with the cylinder head.

18. The system of claim 16, further comprising a first bypass pipe branching from the first exhaust manifold and a second bypass pipe branching from the second exhaust manifold, wherein the first and second bypass pipes meet at a junction point to form a common bypass pipe, and wherein a shut-off element is arranged at the junction point.

19. The system of claim 18, further comprising a non-closable connecting passage permanently connecting the first exhaust manifold and the second exhaust manifold, wherein a cross-sectional area of the connecting passage is smaller than a cross-sectional area of an exhaust pipe.

20. The system of claim 19, wherein the connecting passage permanently connects the first and second bypass pipes, and wherein exhaust flow through the connecting passage maintains a rotational speed of the first turbine at or above a minimum rotational speed.
